(19) United States
(12) Patent Application Publication
(10) Pub. No.: US 2017/0055786 A1
(43) Pub. Date: Mar. 2, 2017

(54) DRY SIDE DUAL TOWEL DEVICE

(71) Applicant: David Francis Tyszka, St. Petersburg, FL (US)

(72) Inventor: David Francis Tyszka, St. Petersburg, FL (US)

(21) Appl. No.: 14/835,148

(22) Filed: Aug. 25, 2015

(51) Int. Cl. A47K 10/02; B32B 7/12; B32B 3/08; B32B 7/08

(52) U.S. Cl. CPC A47K 10/02; B32B 7/08; B32B 7/12; B32B 3/08; B32B 2250/03; B32B 2255/02

(57) ABSTRACT

A triple layer absorbent device having two absorbent layers disposed opposite one another and attached on either side of a central base layer. Adhesives, glue and or sewing is used to attach the three layers together. An optional pouch is attached to on one or both outer layers for porting of items therein.

### FIELD OF THE INVENTION

The present invention relates to devices utilized to dry the human body; more particularly, the present invention is directed to enhancing the absorbing efficiency of the drying devices.

### BACKGROUND OF THE INVENTION

In the summer months, there is a rush of people to get to various aquatic recreational areas including beaches, lakes, pools and the like. Upon arrival, a user typically stretches out his or her towel on a chair, lounge recliner, the beach or other surface. After some time applying sun protection factor lotions, users typically enjoy a day of multiple entries into the water as well as sports, food and other amusements present in their venue of choice. However, at the end of the day many people face the problem of getting into their cars in their wet bathing suits as these have typically not fully dried off This presents the problem of spreading salty liquid and residue on the seats and interior surfaces of the vehicle.

Additionally, when a user actuates his drying device at home after a bath, he or she typically uses the same towel day after day. Thus, on a subsequent day the same drying device is used even though it has not fully dried off This presents the problem that a user can not get a quick dry of his bodily surfaces as there is still liquids stored within the fibers of the drying device.

Accordingly, there needs to be some solution to overcome the aforementioned problems.

### SUMMARY OF THE INVENTION

The present invention overcomes the deficiencies of the known art and the problems that remain unsolved by providing

An absorbent device comprising:
a first fibrous material layer having a first side, a second side and a first edge integral therewith and communicative between the first side and the second side such that the first fibrous material layer forms an attachment along a first side to a third side of
a base layer having a third side, a fourth side and a second edge integral therewith and communicative between the third and fourth sides such that the fourth side of the base layer forms an attachment to a fifth side of
a second fibrous material layer having a fifth side, a sixth side and a third edge integral therewith and communicative between the fifth side and the sixth side such that the second fibrous material layer forms an attachment along a fifth side to the fourth side of the base layer.

In another aspect, wherein the attachment is from a group of: adhesive, glue, and sewing.

In another aspect, wherein the attachment is adhesives and sewing.

In another aspect, wherein the attachment is glue and sewing.

In another aspect, further comprising:
a pouch device attached to the absorbent device.

In another aspect, further comprising:
a flap for closing the pouch device.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents a drying device as disclosed in an embodiment herein. The three component layers of the Dry Side Dual Towel Device are shown including a central base disposed between two liquid capturing layers of fibrous material.

FIG. 2 shows a Dry Side Dual Towel Device in an embodiment where the central base layer has an adhesive disposed on both sides thereof for attachment to a side of the other two respective layers.

FIG. 3 shows a Dry Side Dual Towel Device in an embodiment where the central layer is attached to the other two layers using sewing along an edge and as needed elsewhere.

FIG. 4 shows a Dry Side Dual Towel Device having a pouch in an embodiment.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The Dry Side Dual Towel Device is a unitary device comprising three primary component layers that are integrally associated; a first liquid capturing device, a central base and a second liquid capturing device where the first liquid capturing device and the second liquid capturing device are disposed on opposite sides of the central base. In order to suitably capture liquids and associated solids on the fibrous material of one component layer whilst maintaining a dry component on the other side, a central base layer is disposed there between made from suitable impermeable membranes such as a flexible plastic sheet used in diapers.

The impermeability of the membrane is understood to be within the scope of the material limitations of this or other typical waterproof material. Thus, the waterproof material of the central base can repel liquids and associated solids back towards the liquid capturing devices from which these originally originated.

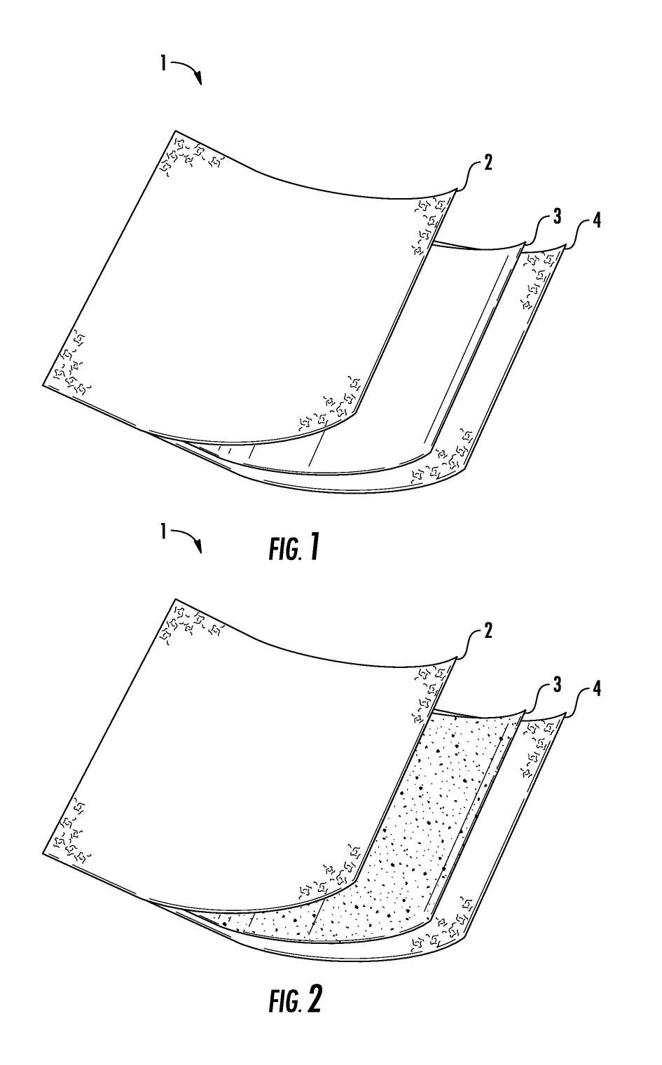

FIG. 1 presents a drying device as disclosed in an embodiment herein. The three component layers of the Dry Side Dual Towel Device are shown including a central base disposed between two liquid capturing layers of fibrous material. The Dry Side Dual Towel Device 1 of FIG. 1 is shown having two liquid capturing layers 2 and 4 respectively positioned to the left and right of a central base layer shown as item 3 in the figure. It should be understood that each of the layers 2, 3, 4 have two sides each.

The fabric material of the two liquid capturing layers 2 and 4 are alternatively sewn or adhesively attached to opposing surfaces of the central base 3 waterproof layer. As a final possibility in construction, these can be attached to opposing sides of the central base 3 with adhesives as well as being sewn thereto.

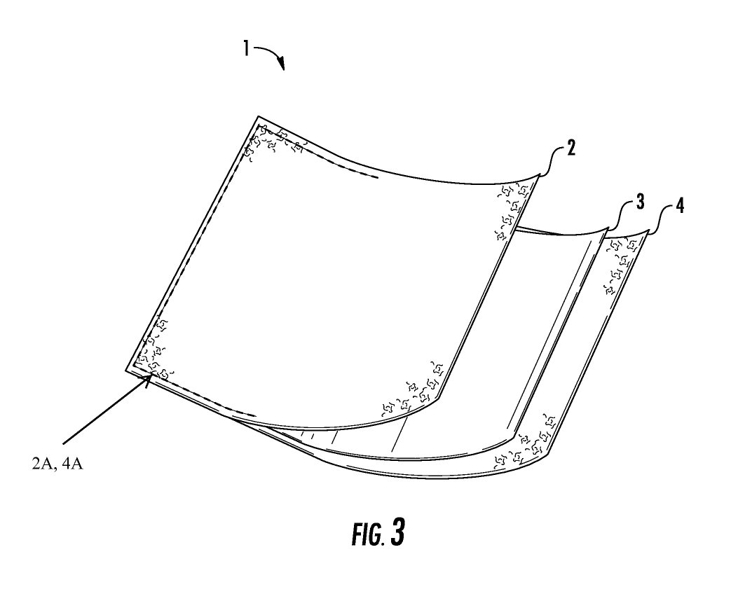

FIG. 2 shows a Dry Side Dual Towel Device in an embodiment where the central base layer has an adhesive disposed on both sides thereof for attachment to a side of the other two respective layers. Thus, the two liquid capturing layers 2, 4 having two sides each are attached along a side each to a corresponding side of the central base layer 3 forming the Dry Side Dual Towel Device.

FIG. 3 shows a Dry Side Dual Towel Device in an embodiment where the central layer is attached to the other two layers using sewing along a peripheral edge and as needed elsewhere. Thus, the two liquid capturing layers 2, 4 having two sides each are attached along a side each to a corresponding side of the central base layer 3 forming the Dry Side Dual Towel Device. In the drawing only a portion of the sewing line 2A, 4A along the peripheral edge is shown but it should be understood that this continues until the three layers are combined into an integral whole forming a singular flat planar device.

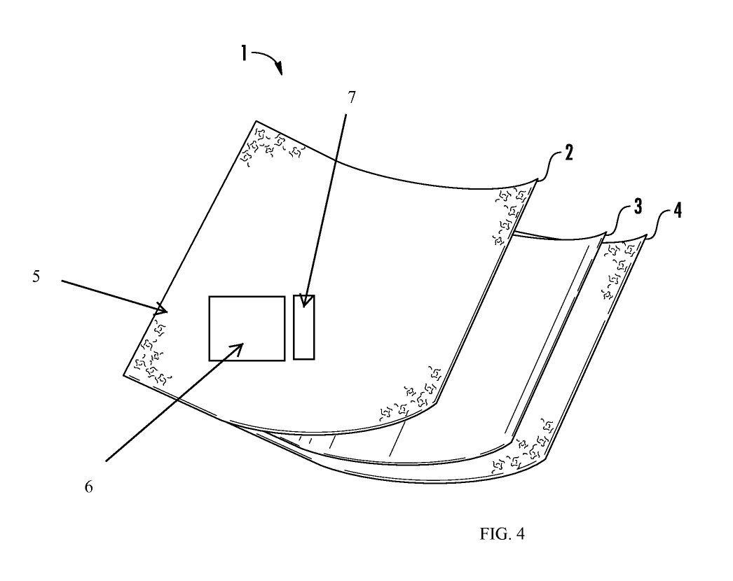

FIG. 4 shows a Dry Side Dual Towel Device having an optional pouch in an embodiment. This pouch is generally referred to as 5 in the drawing and used for carrying items therein. A square or rectangular piece(s) of material 6 forms a pouch 5 with the liquid capturing device 2, 4 top surface, when sewn and or glued along three sides thereof to the top surface of one of the liquid capturing devices 2, 4 and this pouch 5 is used to carry items therein. Of course the sewing or gluing thereto can include attached all the way through the three layers as needed. For example, sewing is self explanatory as the needle passes through one or more layers as needed; gluing or adhesive application typically happens along an outer surface of the absorbent liquid capturing layers 2, 4 but are optionally extended through all three layers by perforating these and applying the adhesive or glue in this perforation and along exposed surfaces of the topmost liquid capturing layers and along the other layers through the perforation.

Another piece of material forms a flap 7 at the top thereof by being sewn to a portion of liquid capturing device 2, 4 near the final side of pouch 6 that is not sewn thereto; thus, this edge and the surface of the liquid capturing device 2, 4 forms an opening for which items may be placed in and retrieved from the optional pouch 5. The flap 7 optionally has one side having the hooks and or loops typically formed in velcro attachment devices. The piece of material 6 would optionally have a corresponding portion of velcro loops and or hooks to engage the flaps velcro.

Thus, when utilizing a Dry Side Dual Towel Device as taught herein, a user merely has to position the liquid capturing device layer that is wet next to his or her body to keep a vehicle dry whenever they seek to keep these interior surfaces from getting wet. In the case of boarding a car, whilst having wet bathing clothes, a user places the dry side liquid capturing device to the car seat and sits on the wet side liquid capturing device thereby protecting the car interior surfaces from becoming contaminated with the liquid from the wet side liquid capturing device.

In contradistinction to that usage, a user that wants to protect him or herself from getting wet whilst sitting on a wet seat at an event or whilst sitting on a seating device such as a stool, chair, patio furniture and similar out door equipment, would do the opposite as in the previous case. Thus, by placing the wet liquid capturing side on the wet seat he or she is able to stay dry sitting on the dry side liquid capturing side.

Other possible uses for the Dry Side Dual Towel Device are as a floor mat, dry item storage, and wet item storage. In the first cast, Dry Side Dual Towel Device can be used as a floor mat, by placing the dry liquid capturing device face down and using the wet liquid capturing device face up. Thus, a user can put their wet, slushy, muddy boots, shoes, or feet upon the wet liquid capturing device. This can be utilized in many parts of the home or office such as on floor boards, entrance ways, bathtub / shower exits, sliding doors, kitchen counter, sinks and more.

Finally, a user may want to use the Dry Side Dual Towel Device to keep small objects dry by placing them in an optional pouch area (available with some Dry Side Dual Towel Device) or wrapping the object in the dry side liquid capturing device. Alternatively, a user may want to keep a sweating bottle from getting other objects wet by either placing it in the optional pouch (available with some Dry Side Dual Towel Device or wrapping it in the dry side liquid capturing device.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

What is claimed is:

1. An absorbent device comprising:
a first fibrous material layer having a first side, a second side and a first edge integral therewith and communicative between the first side and the second side such that the first fibrous material layer forms an attachment along a first side to a third side of
a base layer having a third side, a fourth side and a second edge integral therewith and communicative between the third and fourth sides such that the fourth side of the base layer forms an attachment to a fifth side of
a second fibrous material layer having a fifth side, a sixth side and a third edge integral therewith and communicative between the fifth side and the sixth side such that the second fibrous material layer forms an attachment along a fifth side to the fourth side of the base layer.

2. The absorbent device of claim 1, wherein the attachment is from a group of: adhesive, glue, and sewing.

3. The absorbent device of claim 1, wherein the attachment is adhesives and sewing.

4. The absorbent device of claim 1, wherein the attachment is glue and sewing.

5. The absorbent device of claim 1, further comprising:
a pouch device attached to the absorbent device.

6. The absorbent device of claim 5, further comprising:
a flap for closing the pouch device.
